(19) United States
(12) Patent Application Publication
(10) Pub. No.: US 2013/0089699 A1
(43) Pub. Date: Apr. 11, 2013

(54) Oriented Sorghum Strand Boards made with Sorghum Stalks and Processes for Making Same

(71) Applicants: Michael Warren Hurst, San Diego, CA (US); Chusheng Qi, Shaanxi (CN); Vikram Yadama, Pullman, WA (US)

(72) Inventors: Michael Warren Hurst, San Diego, CA (US); Chusheng Qi, Shaanxi (CN); Vikram Yadama, Pullman, WA (US)

(21) Appl. No.: 13/644,767

(22) Filed: Oct. 4, 2012

Related U.S. Application Data
(60) Provisional application No. 61/544,856, filed on Oct. 7, 2011.

(51) Int. Cl. B32B 5/12; B32B 37/02

(52) U.S. Cl. CPC B32B 5/12; B32B 37/02
USPC 428/112; 156/60

(57) ABSTRACT

A composite board having a sorghum stalk material component and a binder component is disclosed together with a corresponding method of manufacture. To prepare the composite board, the sorghum stalk material is harvested, dried and refined into fibers. The fibers are then combined with a binder such as a thermosetting resin. The resin coated fibers are then arranged into a stack having several layers. Within each layer, the resin coated fibers are aligned along a predetermined layer axis. Next, the stack is thermocompressed in a press at a preselected temperature to compress the resin coated fibers to a preselected board thickness.

This application claims priority to provisional U.S. patent application No. 61/544,856 filed Oct. 7, 2011 titled “Oriented Strand Boards made with Sorghum Stalks and Processes for Making Same.” This application is related to provisional U.S. patent application No. 61/544,884 filed Oct. 7, 2011 titled “Composite Boards made with Sorghum Stalks and a Thermoplastic Binder and Processes for making same.” The entire contents of provisional application 61/544,856 and provisional application 61/544,884 are hereby incorporated by reference herein.

### FIELD OF THE INVENTION

The present invention pertains generally to composite boards. More particularly, the present invention pertains to composite boards having oriented agrifiber strands. The present invention is particularly, but not exclusively, useful as an oriented sorghum strand board (OSSB) made from sorghum stalk material and a binder.

### BACKGROUND OF THE INVENTION

Sorghum is a genus of numerous species of coarse, upright growing grasses having stalks ranging in the length from about 5-15 feet long. Sorghum can be grown under a wide range of soil and climatic conditions including arid areas where crops such as corn would require substantial irrigation. The primary cultivated species, sorghum bicolor, grows well in hot, arid climates, making it popular with subsistence farmers.

In addition to the classification of Sorghum into species, the sorghum species and hybrids are often classified into sorghum types. Types include grain sorghum, forage sorghum, Sudangrass which is a subspecies of sorghum bicolor and Sorghum-sudangrass hybrids (which are a cross between the two forage type sorghums) and Sorghum-almum. Forage Sorghums includes sorgo, sweet sorghum, dual purpose (grain and forage) varieties, and hybrids. Sweet sorghum and forage sorghum hybrids are often used for ethanol production and are sometimes referred to as energy sorghums. As provided further below, the stalks of so-called energy sorghums may be particularly suitable for use in making composite boards such as OSB due to their superior strength and properties.

Sorghum is used for both grain and fodder production and has been identified as a possible source of ethanol as it provides high biomass yield with much lower irrigation and fertilizer requirements than corn. Grain sorghum is grown in the United States, Mexico, India, and throughout Africa and South Asia. It is considered the fifth most important cereal crop in the world. Notably, sorghum straw is a rapidly renewable resource—it can grow more than 2 m (6 ft) tall in a single season. Similar wood growth can take many years. Sorghum stalks are far thicker and more substantial than wheat or rice straw, allowing for better engineering of the product. The center of a sorghum stalk is far less dense than the hard outer ring, so the material can be compressed to different degrees. The sorghum crop is frequently grown using less fertilizers and pesticides than other grains, the material is low in chemical residues. As an added benefit, it is naturally resistant to many types of fungi and insects.

Sorghum stalks and sorghum stalk bagasse (the stalk material remaining after juice extraction for ethanol production) are currently used for thatch, fences, baskets, brushes, paper and cattle fodder. However, the supply of Sorghum stalks and sorghum stalk bagasse greatly exceeds demand, and as a consequence, a large amount of this material is either plowed under or burned. Specifically, in many parts of the world, the straw is burned in the field. After harvest time, the burning can be so plentiful that the skies darken with soot. Traveling miles across the landscape, the resulting smoke plumes are so thick they can be seen in photos taken from outer space. It not only pollutes the air, but emits greenhouse gases (GHGs) linked to the current climate crisis.

Utilizing agricultural waste diverts it from this process, eliminating a source of GHGs and large-particle air pollution. Another green aspect of using waste stalks such as Sorghum as a raw material is the embedded energy to produce agrifiber panels is less than with wood panels. In making both composite wood and agrifiber boards, moisture inside cells or between them must be removed for proper penetration of binder. Agrifibers generally have larger cellulose cells than wood, so the cell wall is softer and thinner, and moisture removal requires less energy.

The cellulose of agrifiber cell walls such as Sorghum is more easily penetrated by chemicals than similar structures in wood fiber, making modifications to improve material properties more effective. For example, agents such as acetyls (commonly used in engineered wood panels to improve dimensional stability, moisture resistance, and strength) are more effective when treating agrifiber stalks such as Sorghum. Ease of cell penetration in agrifiber such as Sorghum stalk material also makes it more likely than wood to accept new green binders such as soybean protein, modified flour pastes, or even recycled thermosetting plastics.

Agrifiber board based on sorghum straw (i.e. sorghum stalks) offers an environmentally responsible product useful as a direct substitute for commercially available wood based particleboard, wood based medium-density fiberboard (MDF), plywood and wood based oriented strand board (OSB). In performance, environmental impact, and cost, it is comparable to or better than those wood-based products, and unlike many of them, can be formulated to emit neither formaldehyde nor volatile organic compounds (VOCs). Moreover, the nature of the sorghum stalk makes it a better fiber for construction than many other agrifiber materials.

Traditional wood-based oriented strand board (OSB) also known as waferboard, Sterling board, Exterior board and SmartPly is a structural wood composite formed by layering strands (flakes) of wood in specific orientations.

Traditional wood-based oriented strand board (OSB) is a mat-formed panel made of wood strands, also called flakes, sliced in the long direction from small diameter, fast growing round wood logs, such as freshly harvested aspen poplar, southern yellow pine or other mixed hardwood and softwood logs, and bonded with an exterior-type binder under heat and pressure.

Traditional wood-based OSB is typically manufactured by layering wood strands ranging in length from about 3½″ to 6″ and approximately 1″ wide. The strands are coated with wax and resin binders (95% wood, 5% wax and resin) and then compressed and bonded together in a thermal press. Layers are created by shredding the wood into strips, which are sifted and then oriented, for example, using belts or wire cauls. Generally, the layers are built up with the external layers aligned in the panel's strength axis with internal layers cross-oriented. The finished product has similar properties to plywood, but is cheaper and more uniform.

Binders used to produce traditional wood-based OSB panels include thermosetting plastic resins such as urea formaldehyde (UF), phenolic resins such as phenol formaldehyde (PF) and formaldehyde-free, isocyanate resins such as polymeric methylene diphenyl diisocyanate (PMDI).

Products such as traditional wood-based OSB made with resins such as UF and PF which release formaldehyde and other volatile organic compounds (VOC's) over the life of the product may be hazardous as formaldehyde is a known carcinogen and formaldehyde emissions have been linked to respiratory illness, asthma and premature death, especially for children and the elderly.

As used herein, formaldehyde-free binder means that the binder does not contain non-trace amounts of formaldehyde or materials that release formaldehyde during the life of the product.

As used herein, the term “Volatile organic compound” means materials having organic chemicals that have a high vapor pressure at ordinary, room-temperature conditions. Their high vapor pressure results from a low boiling point, which causes large numbers of molecules to evaporate from the liquid or solid form of the compound and enter the surrounding air. An example is formaldehyde, with a boiling point of −19° C. (−2° F.), slowly exiting paint and getting into the air. The term “zero VOC” means a material having zero detectable VOC's using standard detection equipment.

Traditional wood-based OSB is suitable as a structural panel for a wide range of construction and industrial applications. The most common uses of traditional OSB include sheathing in walls, floors, and roofs. Panels are available in nominal 4′×8′ sheets (1220×2440 mm) or larger, and thicknesses of ¼″, ⅜″, 7/16″, 15/32″, 19/32″, 23/32″, ⅞″, 1⅛″ and 1¼″. OSB is also used extensively for the webs of prefabricated wood Hoists and in structural insulated panels (SIPS), also known as foam-core sandwich panels. Property specifications for a typical traditional wood-based 0513 (CSA O437; Grade O-2) include minimum modulus of rupture, parallel (29.0 MPa) perpendicular (12.4 MPa); minimum modulus of elasticity, parallel (5500 MPa), perpendicular (1500 MPa); minimum internal bond (0.345 MPa); maximum linear expansion, oven dry to saturated, 0.35% parallel, 0.50% perpendicular; maximum thickness swell, 15% for ½″ thick or less, 10% for greater than ½″; Minimum lateral nail resistance of 70t N, where t=thickness in millimeters.

Properties of Wood-Base Fiber, Agrifiber and Particle Panel may be tested in accordance with ASTM D 1037-99. These properties can include Moisture Absorption, Thickness Swelling, Volume Swelling and Linear Expansion.

The modulus of rupture (MOR) and modulus of elasticity (MOE) can be determined by a static, three point bending test in accordance with ASTM D 1037-99. The internal bond strength (IB) can be determined by testing tensile strength perpendicular to the OSB surface in accordance with ASTM D 1037-99.

Other Test standards suitable for Evaluating Properties of Wood-Base. Fiber, Agrifiber and Particle Panel include;

| Test Standard | Physical Property to be Established |
|---|---|
| USFPL 1344 | Mold Resistance |
| ASTM E-661 Method A | Concentrated Impact Load resistance |
| ASTM D-1761/1037 | Fastener Holding Performance |
| ASTM D-3043 Method C | Panel Bending Strength and Stiffness |
| ASTM D-3501 Method B | Panel Compression Properties |
| ASTM D-1037: | Linear Expansion - Humidity Change |
| | (108-111) |
| ASTM D-1037: | Strength Properties: Static Bending |
| | (11-20) |
| ASTM D-1037: | Tensile Strength Parallel to Surface |
| | (21-27) |
| ASTM D-1037: | Tensile Strength Perpendicular to Surface |
| | (28-33) |
| ASTM D-1037: | Direct Screw Withdrawal Test (61-67) |
| ASTM D-1037: | Abrasion Resistance by the U.S. Navy Wear |
| | Tester (96-99) |
| ASTM D-1037 | Linear Variation with Change in Moisture |
| | Content (108-111) |
| ASTM D-1037: | Interlaminar Shear (122-129) |

Test methods for Evaluating Formaldehyde Emission and Content Properties of Wood-Base Fiber, agrifiber and Particle Panel include;

Large Chamber (ASTM E1333)

Desiccator (ASTM D5582)

Small Chamber (ASTM D6007)

Japanese 24 Hour Desiccator (JIS A1460)

Perforator (EN 120), Single Extraction

Perforator (EN 120), Duplicate Extraction

Unless otherwise specified, all test results reported herein were conducted using the test methods provided above.

In light of the above, it is an object of the present invention to provide oriented sorghum strand board that is made from materials having a relatively low adverse environmental impact. Still another object of the present invention is to provide formaldehyde-free oriented sorghum strand board containing substantially zero VOC's. Yet another object of the present invention is to provide oriented sorghum strand boards that are made with sorghum stalks and processes for making same which are easy to use, relatively simple to implement, and comparatively cost effective.

### SUMMARY OF THE INVENTION

For the present invention, a composite board is disclosed which includes a sorghum stalk material component and a binder component. To prepare the composite board, the sorghum stalk material is first harvested. The sorghum stalk material can include sorghum stalk bagasse (the stalk material remaining after juice extraction for ethanol production) and/or Sorghum stalks. In one particular implementation, stalk material from energy sorghums such as sweet sorghum and forage sorghum hybrids are used. In one implementation, the sorghum stalk material is harvested using a mower/conditioner. In this process, sorghum stalks and first cut (i.e. mowed) at or near their base and conditioned by crimping the stalks every 12 to 18 inches along their length to crack open the epidermis to allow the stalk to air dry at the harvest site.

In some cases, mechanical or chemical processing may be used to remove or peel the waxy outer coating from the stalk material. The stalks may be dried naturally or dried using an industrial dryer to a moisture content of less than about 10% by weight, and more typically, to a moisture content in the range of 7.5 to 9.0%.

The stalk material can then be mechanically processed (either before or after drying) in stalk segments, for example by cutting or breaking the stalk material. Typically, the step involves segmenting stalk material having an initial length of about 8 to 14 feet into segments having a length in the range of about 4 to 20 inches, and more typically in the range of about 4 to 6 inches. After the stalk material has been cut to length, the stalk segments can be refined can reduce the fiber size and split grain sorghum. For this purpose, a mill such as a disc mill may be used. For example, a disc mill have a mill gap set at 0.3 inch can be used.

After cutting and/or milling, the stalks and/or stalk segments may be filtered, screened or cleaned at various times during the process to remove fines, etc. For example, in one implementation, the sorghum is refined and then screened to remove small particles (i.e. fines), leaves, and epidermis. For example, an oscillating screener having two screens, a top screen with 20 mm openings and a bottom screen size with 5 mm openings can be used. In some implementations, the stalks may be softened, for example by water soaking or steaming.

The stalk segments may be mixed with small amounts, e.g. less than 5% by weight, of other fibrous or non-fibrous materials such as wood, other sorghum plant portions, corn plant portions, sugar plant portions, etc.

The dried sorghum stalk material is combined with a binder such as a thermosetting resin. For example, the binder may be sprayed using nozzles onto the sorghum stalk material or may be applied in a tumbler. Other techniques include curtain coating, roller coating and dipping.

In one aspect, a formaldehyde-free, isocyanate resin such as polymeric methylene diphenyl diisocyanate (PMDI) may be used. For example a PMDI resin such Rubinate 1840 sold by Huntsman. A suitable mix ratio of MIDI to stalk material is about 2.7-6.5% by weight of PMDI and about 93.5-97.3% by weight stalk material. In one implementation, a mix ratio of PMDI to stalk material is 3-5% by weight of PMDI and 95-97% by weight stalk material is employed with a target of about 4% by weight of PMDI and about 96% by weight stalk material.

In another aspect, a formaldehyde-free protein based resin may be used. For example, the protein based resin can consist of a soy protein based resin, a canola protein based resin, a castor protein based resin, jatropha protein based resin or a combination of different protein based resins.

A suitable mix ratio of protein based resin to stalk material is 4-12% by weight of protein based resin and 88-96% by weight stalk material. In one implementation, a mix ratio of protein based resin to stalk material is 7-9% by weight of protein based resin and 91-93% by weight stalk material is employed with a target of about 8% by weight of protein based resin and about 92% by weight stalk material.

In another aspect, the binder can include a combination of PMD and a protein based resin.

Once coated, the binder coated sorghum stalk material can be oriented and layered. A typical pre-compressing layer depth in the range of about 4 to 5 inches may be used, with each layer oriented orthogonal to adjacent layers. Layers may be stacked directly on a release coated press platen or the layers may be stacked and then placed onto the platen. A single layer or multiple layers may be used. In one aspect, at least three layers are used. In another aspect, an odd number of layers are used. One or more layers may have stalk material randomly oriented. In one aspect, exterior layers are aligned in parallel. In one aspect, each layer is oriented substantially orthogonal to adjacent layers in the stack. Typically, in each layer, the stalk material is oriented along a layer axis such that at least 90% of said sorghum stalk material is aligned within +/−45 degrees of the layer axis. In some implementations, the stalk material may be combined with binder after orienting and/or layering. In one implementation, one or both of the boards surface layers include 20 to 30 percent by weight of sorghum fines to improve surface finish (i.e. to reduce surface roughness).

The stack of layer(s) is then thermocompressed in a press between heated flat platens. One or more thermocompressions may be employed. Various press temperatures, pressures and durations may be employed depending on the desired board thickness and board density. Typically, thickness and density are specified, and the layer/stack input thickness and press pressure are varied, to obtain the desired final thickness and density. Typically, a precompressed layer thickness of about 4-5 inches will compress to about ½ inch. After pressing, the board may be trimmed.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a process flow chart showing steps for preparing an oriented sorghum strand board containing sorghum stalk material and a binder;

FIG. 2 is a perspective view showing a fin/frame assembly for orienting and layering binder coated sorghum stalk material;

FIG. 3 is an isometric view of a stack of binder coated sorghum stalk material having three layers, with each layer oriented orthogonal to adjacent layers;

FIG. 4 is a front plan view of a stack of binder coated sorghum stalk material having three layers positioned between release coated press platens;

FIG. 5 shows a plot of mat pressure (psi) and board thickness (in.) versus time for a thickness controlled press regimen to produce a board having a final desired thickness of about 0.55 inches;

FIG. 6 shows a board after pressing;

FIG. 7 shows the board after trimming; and

FIGS. 8-13 show density modified properties for one layer and three layer boards.

### DESCRIPTION OF THE PREFERRED EMBODIMENTS

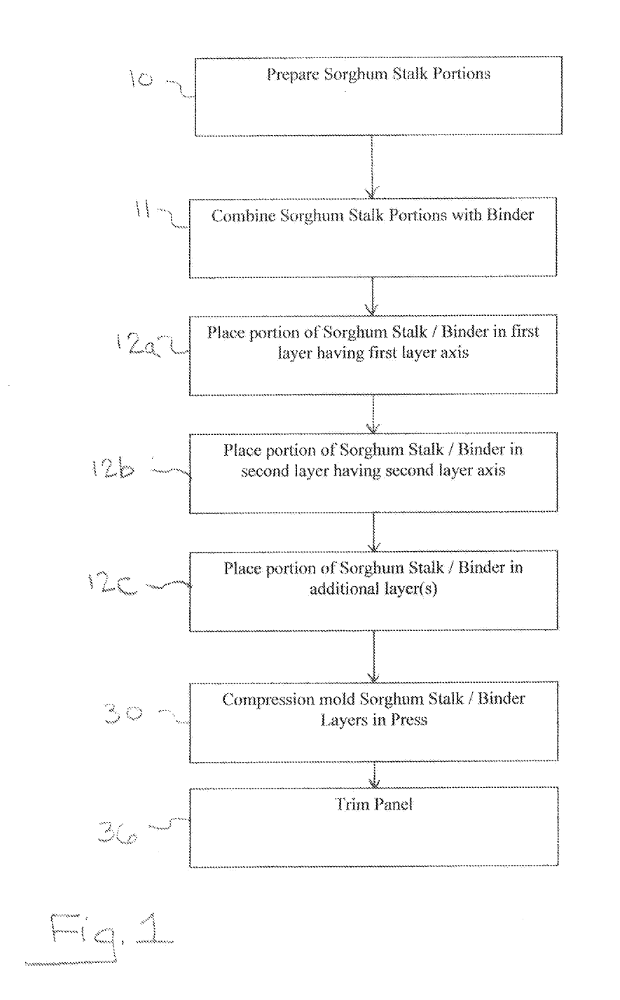

FIG. 1 shows a process for preparing an oriented sorghum strand board containing sorghum stalk material and a binder. Uses of OSSB boards containing sorghum stalk material described herein can include, but are not necessarily limited, to structural panels designed for exterior use in construction and industrial applications such as sheathing in walls, floors, and roofs, for the webs of prefabricated wood I-joists and in structural insulated panels (SIPS), also known as foam-core sandwich panels. As shown in FIG. 1, the process begins by preparing sorghum stalk portions (box 10). More specifically, the sorghum stalk portions can be prepared as described above by stalk harvesting, conditioning, drying, refining and screening. Once prepared, the sorghum stalk portions are combined with binder (box 11), as described above. As indicated above, the binder may include a thermosetting resin such as PMDI and/or a protein based resin such as a soy protein based resin. When used, the soy protein based resin may be produced from soy meal/flour, soy protein concentrate or soy protein isolate. The soy protein based resin may be self-crosslinking or used with a cross linker. The soy protein based resin may be in alkaline form or as a slightly acidic dispersion. For example, the preparation of a soy protein resin having a slightly acidic dispersion can include denaturation of soy flour to expose groups for reaction and adhesion, introduction of viscosity/performance stability; modification and stabilization, for example with CH₂O₂, copolymerization, for example with PMDI; and inversion with acid addition. The soy protein based resin may be denatured and copolymerized with small amounts of reactant to produce a product that is biologically stable.

The soy protein based resin may be, for example, Soyad adhesive product # D-40999 and cross-linker product # D-40767 containing 1,3-dichloropropan-2-ol (1,3-DCP), available from Heartland Resource Technologies, LLC—Ashland. The properties of each are listed in the table below.

| | D-40999 | D-40787 |
|---|---|---|
| | Soyad | Cross-Linker |
| Solids (%) | 50.0 | 45.0 |
| Viscosity (cP) | 1500 | 250 |
| pH | 4.2 | 5.5 |

The method for using these products together is as follows: Mix the two components no more than 4 hours prior to its intended use; charge the Soyad (D-40999) to a mixing vessel; add the cross-linker (D-40767) such that the ratio is 20 parts cross-linker to 100 parts of Soyad on a solids basis; stir material 5-10 minutes such that resultant mixture is homogeneous. The solids, viscosity and pH of the resultant blend will be 49.1%, ˜1000 cP and ˜4.5, respectively.

Continuing with FIG. 1, it can be seen that once the sorghum stalk portions have been combined with binder, the coated sorghum stalk material is placed into one or more layers (boxes 12a-c)

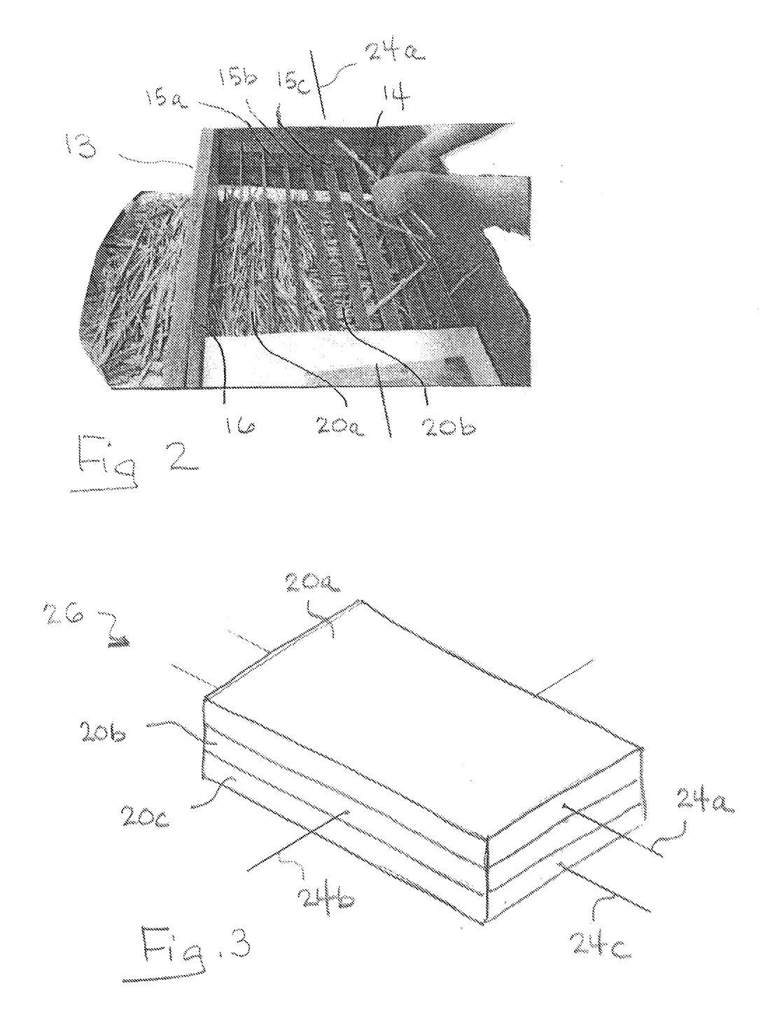

FIG. 2 shows a fin/frame assembly 13 for orienting and layering binder coated sorghum stalk material 14. It can be seen that the fin/frame assembly 13 includes a plurality of spaced apart parallel fins 15a-c that are secured to a wooden frame 16 to establish the fin/frame assembly 13. As shown, the binder coated sorghum stalk material 14 is passed through the fins 15a-c to produce layer 20a on top of previously deposited layer 20b. As shown, the fins 15a-c are aligned parallel to a desired layer axis 24a for the layer 20a. Once a layer 20a,b is complete, the fin/frame assembly 13 can be lifted and reoriented, e.g. rotated, to prepare for loading stalk material 14 in a subsequent layer. For the fin/frame assembly 13, the height of the fins 15a-c can be used to gauge and regulate the layer height. The number and spacing of the fins 15a-c can be varied to increase or decrease the variation in alignment of the stalk material 14 in the layer 20a,b. The frame 16 can be sized to produce the desired OSSB sheet size, for example, to produce a 4′×8′ sheet, a suitable frame 16 of about 5′×9′ may be employed. Typically, a fin spacing in the range of about 2-3 inches may be used. A typical pre-compressing layer depth in the range of about 4 to 5 inches may be used.

FIG. 3 shows a stack 26 having three layers 20a-c, with each layer 20a-c oriented orthogonal to adjacent layers 20a-c. Specifically, as shown, top layer 20a has a layer axis 24a, layer 20b has a layer axis 24b and bottom layer 20c has a layer axis 24c. For FIG. 2, it can be seen that layer axis 24a is substantially parallel to layer axis 24c and layer axis 24b is substantially orthogonal to both layer axis 24a and layer axis 24c. Although three layers 20a-c are shown, it is to be appreciated that more than three and as few as one layer 20a-c may be used. Typically, to produce a board having superior strength along one of the board axes, an odd number of layers 20a-c are used and the exterior layers (e.g. layers 20a and 20c) are aligned in parallel. Typically, as shown in FIG. 2, in each layer 20a, the stalk material 14 is oriented along a layer axis 24a such that at least 90% of said sorghum stalk material 14 is aligned within +/−45 degrees of the layer axis 24a. In some implementations, the stalk material 14 may be combined with binder after orienting and/or layering. As an alternative to the fin/frame assembly 13 shown in FIG. 2, mechanized equipment (not shown) similar to equipment used in traditional wood OSSB manufacturing can be used to orient and layer the coated sorghum stalk material 14.

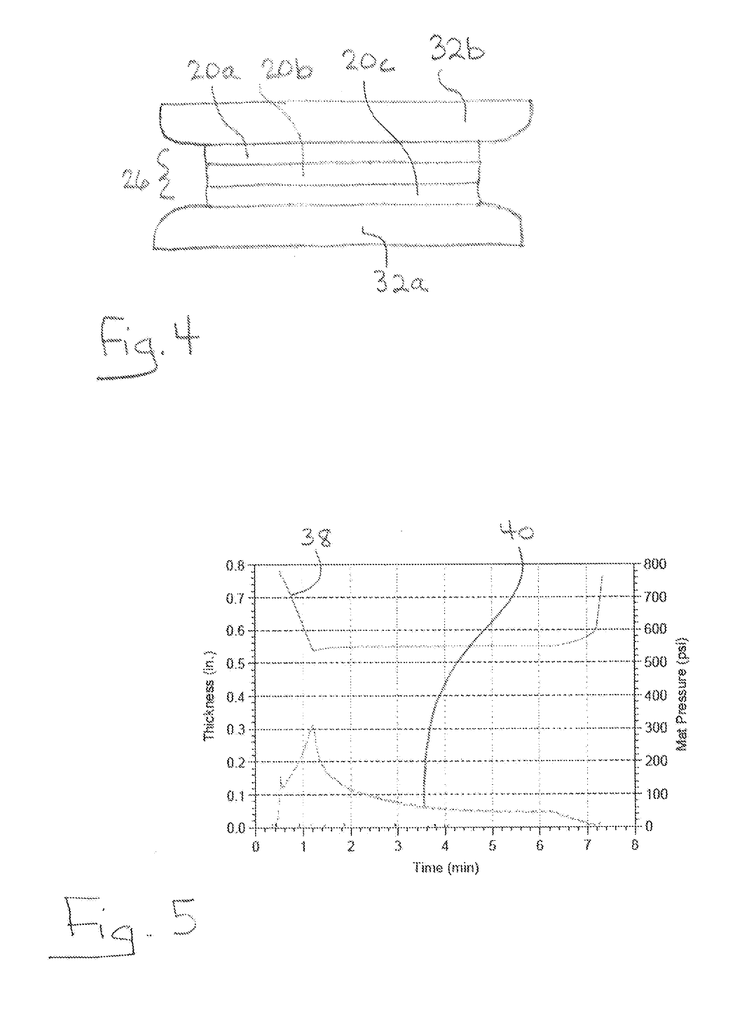

FIG. 1 shows that once the coated sorghum stalk material has been layered, the stack is pressed (box 30). FIG. 4 shows a stack 26 having layers 20a-c positioned between release coated press platens 32a,b. The stack 26 may be layered directly on a press platen 32a or the stack 26 may be layered and then placed onto the platen 32a. Once positioned, the stack 26 of layers 20a-c may be thermocompressed in a press (not shown) between heated flat platens 32a,b. One or more thermocompressions may be employed. Press temperature, pressure and duration may depend on board thickness and desired board density. Typically, thickness and density are specified, and the layer/stack input thickness and press pressure are varied, to obtain the desired final board thickness and density. Typically, a precompressed stack thickness of about 4-5 inches will compress to about ½ inch. Typical range of press temperatures include 125 deg F. to about 400 deg F., typical pressures include 100-300 psi and typical compressions include 2-5 minutes closing time and 3-10 minutes duration. In one implementation, a press temperature of about 150 deg F., press temperature of about 200 psi and a duration of about 5 minutes may be used. FIG. 5 shows a plot of mat pressure (psi) and board thickness (in.) versus time for a thickness controlled press regimen to produce a board having a final desired thickness of about 0.55 inches. Shown plotted are the mat thickness 38 and mat pressure 40. Final board densities range from about 41 to 44 lbs/ft³.

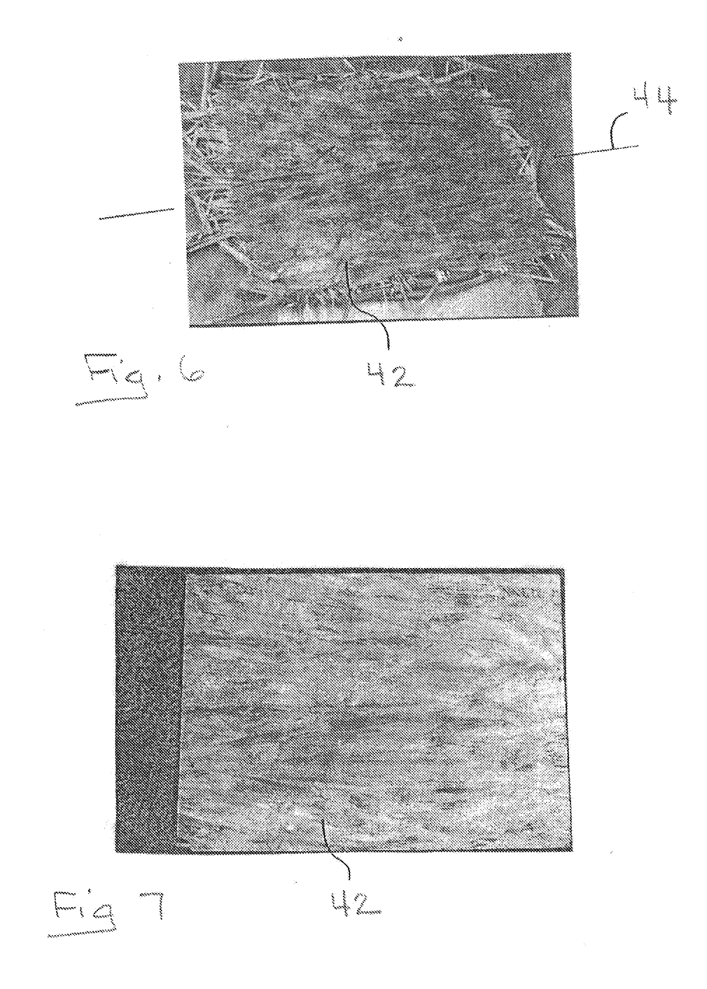

As shown in FIG. 1, after pressing (box 30), the board may be trimmed to size (box 36). FIG. 6 shows a board 42 after pressing having an exterior layer axis 44 (i.e. the top and bottom layer having stalk material aligned along axis 40). FIG. 7 shows the board 42 after trimming.

### Example

Single layer and three layer OSSB boards containing sorghum stalk material were prepared using stalks from energy Sorghum plants: 96% by weight, MIDI; 4% by weight and a final Density: 43.2 lb/ft³. Processing parameters for the three layers composites were:
Hot-pressing temperature: 350 F
Duration: 6 min
Closing time: 4 min
Moisture content: 6%
   Processing parameters for the one layer composites were:
Hot-pressing temperature: 350 F
Duration: 5 min
Closing time: 3 min
Moisture content: 8%

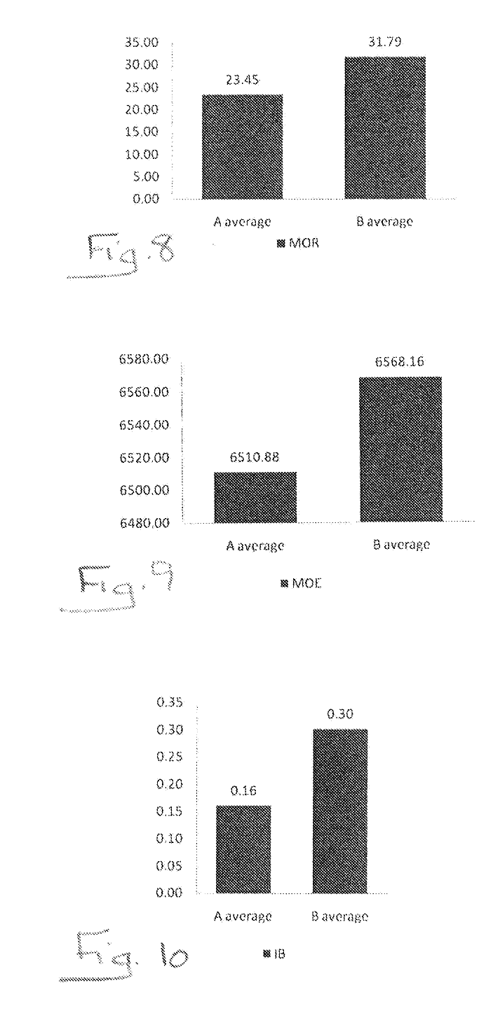

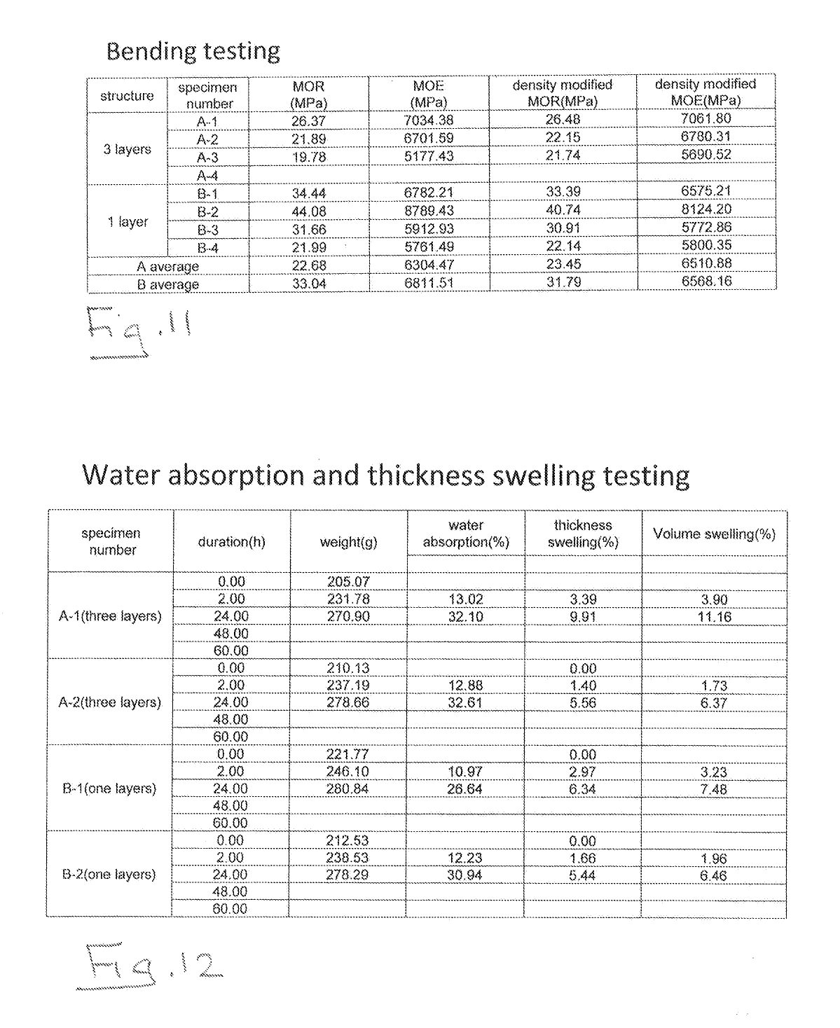

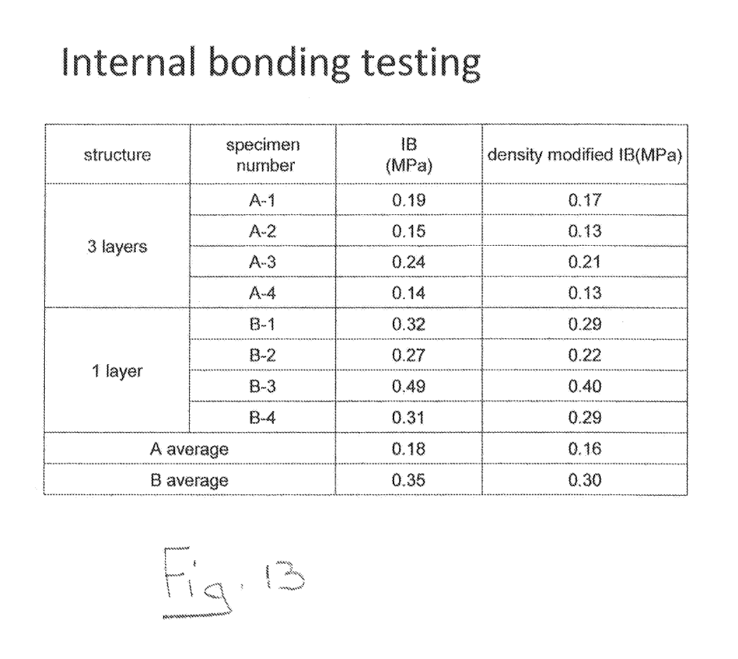

FIGS. 8-13 show density modified properties of the one layer and three layer boards. MOR, MOE and IP properties are influenced by density, and the data shown has been normalized by density.

While the particular embodiment(s) are described and illustrated in this patent application in the detail required to satisfy 35 U.S.C. 112, it is to be understood by those skilled in the art that the above-described embodiment(s) are merely examples of the subject matter which is broadly contemplated by the present application. Reference to an element in the following Claims in the singular, is not intended to mean, nor shall it mean in interpreting such Claim element “one and only one” unless explicitly so stated, but rather “one or more”. All structural and functional equivalents to any of the elements of the above-described embodiments) that are known, or later come to be known to those of ordinary skill in the art, are expressly incorporated herein by reference arid are intended to be encompassed by the present Claims. It is not intended or necessary for a device or method discussed in the Specification as an embodiment, to address or solve each and every problem discussed in this Application, for it to be encompassed by the present Claims. No element, component, or method step in the present disclosure is intended to be dedicated to the public regardless of whether the element, component, or method step is explicitly recited in the Claims. No claim element in the appended Claims is to be construed under the provisions of 35 U.S.C. 112, sixth, paragraph, unless the element is expressly recited using the phrase “means for” or, in the case of a method claim, the element is recited as a “step” instead of an “act”.

What is claimed is:

1. A board comprising at least two oriented strand layers, each oriented strand layer containing a binder material and sorghum stalk portions, each oriented strand layer having a layer axis with greater than 90% of said sorghum stalk portions aligned within +/−45 degrees of said layer axis, and wherein at least one oriented strand layer has a layer axis oriented at a non-zero angle relative to a layer axis of another oriented strand layer.

2. The board as recited in claim 1 wherein said binder material is a formaldehyde-free binder.

3. The board as recited in claim 1 wherein said binder material contains zero volatile organic compounds (VOC).

4. The board as recited in claim 1 wherein said binder material comprises polymeric methylene diphenyl diisocyanate (PMDI).

5. The board as recited in claim 1 wherein said binder material comprises a protein based resin.

6. The board as recited in claim 5 wherein said protein based resin is selected from the group of protein based resins consisting of a soy protein based resin, a canola protein based resin, a castor protein based resin, jatropha protein based resin and combinations thereof.

7. The board as recited in claim 1 wherein said board comprises at least three oriented strand layers including a top oriented strand layer having a top layer axis and a bottom oriented strand layer having a bottom layer axis, and wherein said top layer axis is substantially parallel to said bottom layer axis.

8. The board as recited in claim 1 wherein the sorghum stalk portions comprise sorghum bagasse.

9. The board as recited in claim 1 wherein the sorghum stalk portions comprise energy sorghums

10. The board as recited in claim 1 wherein said board includes 93.5 to 97.3 percent sorghum stalk portions by weight and 2.7 to 6.5 percent binder by weight.

11. The board as recited in claim 1 wherein said board has a density in the range of 41 to 44 lbs./ft³.

12. The board as recited in claim 1 wherein said board has a surface layer and said surface layer comprises 20 to 30 percent by weight of sorghum fines.

13. A method for manufacturing a board, said method comprising the steps of:
combining sorghum stalk portions with a binder material to produce treated sorghum stalk portions;
arranging a portion of said treated sorghum stalk portions in a first layer having a first layer axis with greater than 90% of said treated sorghum stalk portions aligned within +/−45 degrees of said first layer axis;
arranging a portion of said treated sorghum stalk portions in a second layer having a second layer axis with greater than 90% of said treated sorghum stalk portions aligned within +/−45 degrees of said second layer axis; and
heating and pressing said layers.

14. The method of step 13 wherein the combining step is accomplished by coating the sorghum stalk portions with a binder material in a tumbler.

15. The method of step 13 wherein the heating and pressing step is accomplished in a press at a temperature in the range of 125 to 400 degrees Fahrenheit.

16. The method of step 13 wherein the heating and pressing step is accomplished in a press at a pressure in the range of 100 to 300 psi.

17. The method of step 13 wherein said sorghum stalk portions have a moisture content in the range of 7.5 to 9.0 percent when combined with the binder.

18. The method of step 13 further comprising the step of harvesting sorghum by mowing sorghum stalks and conditioning each mowed stalks at the harvest site by crimping the mowed stalk at a plurality of locations to increase sorghum stalk drying.

19. The method of step 13 further comprising the step of refining sorghum stalk material into fibers using a mill and screening the fibers to remove sorghum fines.

20. A board made by a process comprising the steps of:
combining sorghum stalk portions with a binder material to produce treated sorghum stalk portions;
arranging a portion of said treated sorghum stalk portions in a first layer having a first layer axis with greater than 90% of said treated sorghum stalk portions aligned within +/−45 degrees of said first layer axis;
arranging a portion of said treated sorghum stalk portions in a second layer having a second layer axis with greater than 90% of said treated sorghum stalk portions aligned within +/−45 degrees of said second layer axis; and
heating and pressing said layers.
